(19) United States
(12) Patent Application Publication
(10) Pub. No.: US 2025/0259989 A1
(43) Pub. Date: Aug. 14, 2025

(54) ANODE FOR LITHIUM SECONDARY BATTERY AND LITHIUM SECONDARY BATTERY INCLUDING THE SAME

(71) Applicant: SK ON CO., LTD., Seoul (KR)

(72) Inventors: Young Mo YANG, Daejeon (KR); Gwi Ok PARK, Daejeon (KR); Yun Ji LA, Daejeon (KR)

(21) Appl. No.: 19/053,364

(22) Filed: Feb. 13, 2025

(30) Foreign Application Priority Data
Feb. 14, 2024 (KR) 10-2024-0021166

(51) Int. Cl. H01M 4/134; H01M 4/02; H01M 4/38; H01M 4/62; H01M 10/0525

(52) U.S. Cl. CPC H01M 4/134; H01M 4/386; H01M 4/622; H01M 4/625; H01M 4/626; H01M 10/0525; H01M 2004/021; H01M 2004/028

(57) ABSTRACT

An anode for a lithium secondary battery according to embodiments of the present disclosure includes an anode current collector, and an anode active material layer which is disposed on at least one surface of the anode current collector, includes a silicon-based active material, and has a Li/Si ratio of 0.03 to 0.06.

### CROSS-REFERENCE TO RELATED APPLICATION

This patent application claims the priority and benefits of Korean patent application No. 10-2024-0021166, filed on Feb. 14, 2024, the disclosure of which is incorporated herein by reference in its entirety.

### BACKGROUND

### 1. Field of the Invention

The present disclosure relates to an anode for a lithium secondary battery and a lithium secondary battery including the same.

### 2. Description of the Related Art

A secondary battery is a battery which can be repeatedly charged and discharged. With rapid progress of information and communication, and display industries, the secondary battery has been widely applied to various portable electronic telecommunication devices such as a camcorder, a mobile phone, a laptop computer as a power source thereof. Recently, a battery pack including the secondary battery has also been developed and applied to an eco-friendly automobile such as an electric vehicle, a hybrid vehicle, etc., as a power source thereof.

Examples of the secondary battery may include a lithium secondary battery, a nickel-cadmium battery, a nickel-hydrogen battery and the like. Among them, the lithium secondary battery has a high operating voltage and a high energy density per unit weight, and is advantageous in terms of a charging speed and light weight, such that development thereof has been proceeded in this regard.

Recently, as subjects, to which the lithium secondary battery is applied, are expanded, development for a lithium secondary battery having a higher capacity and output has been proceeded. For example, a composite compound of silicon and carbon having high capacity may be prepared and used for an anode active material.

However, an anode including silicon has an increased volume expansion rate, which may result in a decrease in lifespan characteristics according to repeated charging and discharging.

### SUMMARY

According to an aspect of the present disclosure, it is an object to provide an anode for a lithium secondary battery having improved lifespan characteristics and output characteristics.

According to another aspect of the present disclosure, it is an object to provide a lithium secondary battery which includes the anode having improved lifespan characteristics and output characteristics.

To achieve the above objects, according to an aspect of the present disclosure, there is provided an anode for a lithium secondary battery including: an anode current collector; and an anode active material layer which is disposed on at least one surface of the anode current collector, includes a silicon-based active material, and has a Li/Si ratio of 0.03 to 0.06 defined by Equation 1 below:

Li/Si ratio=CLi/CSi [Equation 1]

In Equation 1, CLi is a content of lithium based on a total weight of the anode active material layer in a discharged state, and CSi is a content of silicon based on the total weight of the anode active material layer in the discharged state.

In some embodiments, the Li/Si ratio may be 0.0335 to 0.0454.

In some embodiments, the silicon-based active material may include silicon metal.

In some embodiments, the content of silicon based on a total weight of the silicon metal may be 80% by weight to 100% by weight.

In some embodiments, the silicon-based active material may include a carbon coating disposed on a surface portion thereof.

In some embodiments, the CSi of Equation 1 may be 17.59% by weight to 24.74% by weight.

In some embodiments, the Li/Si ratio may be measured through inductively coupled plasma (ICP) analysis.

In some embodiments, the anode active material layer may further include a conductive material.

In some embodiments, the conductive material may include at least one selected from the group consisting of graphite, carbon black, acetylene black, Ketjen black, graphene, carbon nanotube, vapor-grown carbon fiber (VGCF), carbon fiber, tin, tin oxide, titanium oxide, LaSrCoO₃ and LaSrMnO₃.

According to another aspect of the present disclosure, there is provided a lithium secondary battery including: the above-described anode for a lithium secondary battery; and a cathode disposed to face the anode.

In some embodiments, a loading amount ratio defined by Equation 2 below may be 35% to 60%:

Loading amount ratio (%)=(LC/LA)×100 [Equation 2]

In Equation 2, LC is a loading amount (mg/cm²) of the cathode, and LA is a loading amount (mg/cm²) of the anode.

In some embodiments, the loading amount ratio may be 40% to 50%.

According to an embodiment of the present disclosure, initial efficiency and capacity retention rate of the lithium secondary battery may be improved while maintaining or enhancing capacity characteristics of the anode.

According to an embodiment of the present disclosure, excessive volume expansion of the anode may be suppressed, and the initial efficiency and lifespan characteristics may be improved.

The anode for a lithium secondary battery and the lithium secondary battery including the same of the present disclosure may be widely applied to green technology fields such as an electric vehicle, and a battery charging station, as well as other solar power generation and wind power generation using the batteries. In addition, the anode for a lithium secondary battery and the lithium secondary battery including the same of the present disclosure may be used in an eco-friendly electric vehicle, and a hybrid vehicle, etc., which are intended to prevent climate change by suppressing air pollution and greenhouse gas emissions.

### BRIEF DESCRIPTION OF THE DRAWINGS

The above and other objects, features and other advantages of the present disclosure will be more clearly understood from the following detailed description taken in conjunction with the accompanying drawings, in which:

FIGS. 1 and 2 are a schematic plan view and a cross-sectional view of a lithium secondary battery according to exemplary embodiments, respectively.

### DETAILED DESCRIPTION OF THE INVENTION

Embodiments of the present disclosure provide an anode for a lithium secondary battery (hereinafter, may be abbreviated as an “anode”) which includes an anode active material layer. In addition, a lithium secondary battery (hereinafter, may be abbreviated as a “secondary battery”) which includes the anode is provided.

Hereinafter, the embodiments of the present disclosure will be described in detail. However, these embodiments are merely an example, and the present disclosure is not limited to the specific embodiments described as the example.

In exemplary embodiments, the anode may include an anode current collector, and an anode active material layer which is disposed on at least one surface of the anode current collector and includes an anode active material including a silicon-based active material. The anode active material may include a plurality of silicon-based active material particles.

The term “silicon-based active material” as used herein may refer to an active material containing a silicon element.

For example, the anode current collector may include a copper foil, a nickel foil, a stainless steel foil, a titanium foil, a nickel foam, a copper foam, a polymer substrate coated with conductive metal and the like. These may be used alone or in combination of two or more thereof. For example, the anode current collector may have a thickness of 10 to 50 μm.

In exemplary embodiments, the silicon-based active material may include silicon metal. Accordingly, an energy density of the anode may be improved.

In some embodiments, a content of silicon based on a total weight of the silicon metal may be 80% by weight (“wt %”) to 100 wt %, and in one embodiment, 85 wt % to 99.9 wt %. Within the above range, capacity characteristics of the anode may be improved through a high purity silicon-based active material.

In some embodiments, the anode may further include a graphite-based active material. The graphite-based active material may include at least one selected from the group consisting of natural graphite and artificial graphite. For example, the graphite-based active material may have shapes such as an amorphous, planar, flaky, spherical or fibrous shape, etc.

The term “graphite-based active material” used herein may refer to an active material which contains graphite and does not contain a silicon element.

For example, a content of the silicon-based active material particles based on the total weight of the anode active material may be 3 wt % or more, 5 wt % or more, 10 wt % or more, 15 wt % or more, 20 wt % or more, 25 wt % or more, 30 wt % or more, 35 wt % or more, 40 wt % or more, or 45 wt % or more.

For example, the content of the silicon-based active material particles based on the total weight of the anode active material may be 100 wt % or less, 95 wt % or less, 90 wt % or less, 85 wt % or less, 80 wt % or less, 75 wt % or less, 70 wt % or less, 65 wt % or less, 60 wt % or less, 55 wt % or less, or 50 wt % or less.

In one embodiment, the anode active material may be substantially composed of the silicon-based active material.

In exemplary embodiments, a Li/Si ratio of the anode active material layer defined by Equation 1 below may be 0.03 to 0.06, and in some embodiments, 0.0335 to 0.0454.

Li/Si ratio=CLi/CSi [Equation 1]

In Equation 1, CLi is a content of lithium based on a total weight of the anode active material layer in a discharged state. CSi is a content of silicon based on the total weight of the anode active material layer in the discharged state.

Within the above Li/Si ratio range, a ratio of a silicon element to a lithium element existing in the anode in the discharged state may be appropriately adjusted. Accordingly, the initial efficiency and lifespan characteristics of the secondary battery may be improved.

For example, the Li/Si ratio may be comprehensively controlled by adjusting whether carbon coating of the silicon-based active material is performed, a content of a conductive material in the anode, a composition of the cathode, a ratio of a cathode loading amount to an anode loading amount, etc.

In some embodiments, the CSi of Equation 1 above may be 17.59 wt % to 24.74 wt %, and in one embodiment, may be 20.25 wt % to 23.88 wt %. Within the above range, the initial efficiency and capacity retention rate of the anode may be improved while enhancing or maintaining the capacity characteristics thereof.

In some embodiments, the Li/Si ratio may be measured by inductively coupled plasma (ICP) analysis.

For example, by performing ICP analysis on the anode active material layer, the content of lithium element (CLi) based on the total weight of the anode active material layer and the content of silicon element (CSi) based on the total weight of the anode active material layer may be measured, respectively. Measurement results may be substituted into Equation 1 to obtain the Li/Si ratio.

In some embodiments, the silicon-based active material may further include a carbon coating disposed on a surface portion thereof. Accordingly, a side reaction of the silicon element of the silicon-based active material may be suppressed, thereby improving the lifespan characteristics and capacity characteristics of the secondary battery.

For example, the silicon-based active material may include silicon metal and a carbon coating disposed on the surface of the silicon metal.

In one embodiment, the carbon coating may include at least one of carbon and a conductive polymer. For example, the carbon may include amorphous carbon. For example, the conductive polymer may include polyacetylene, polyaniline, polypyrrole, polythiophene and the like.

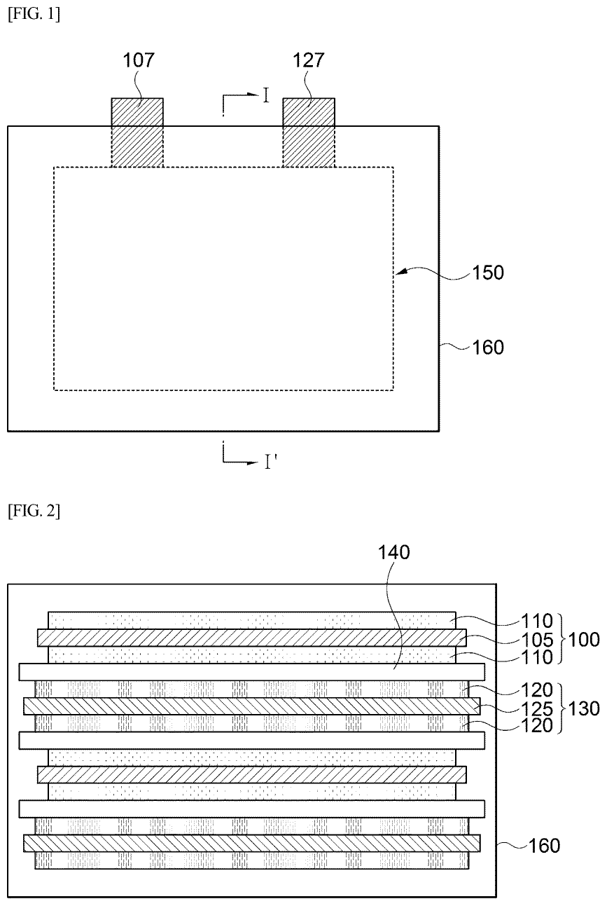

FIGS. 1 and 2 are a schematic plan view and a cross-sectional view illustrating a lithium secondary battery according to exemplary embodiments, respectively. For example, FIG. 2 is a cross-sectional view taken on line I-I′ of FIG. 1 in a thickness direction of the lithium secondary battery.

The lithium secondary battery may include the above-described anode 130 and a cathode 100 disposed to face the anode 130.

The cathode 100 may include a cathode current collector 105, and a cathode active material layer 110 formed on at least one surface of the cathode current collector 105.

The cathode current collector 105 may also include stainless steel, nickel, aluminum, titanium or an alloy thereof. The cathode current collector 105 may also include aluminum or stainless steel subjected to surface treatment with carbon, nickel, titanium or silver. For example, the cathode current collector 105 may have a thickness of 10 to 50 μm.

The cathode active material layer 110 may include a cathode active material. The cathode active material may include a compound capable of reversibly intercalating and deintercalating lithium ions.

According to exemplary embodiments, the cathode active material may include a lithium-nickel metal oxide. The lithium-nickel metal oxide may further include at least one of cobalt (Co), manganese (Mn) and aluminum (Al).

In some embodiments, the cathode active material or the lithium-nickel metal oxide may include a layered structure or crystal structure represented by Formula 1 below.

LiₓNiₐM_{b}O_{2+z} [Formula 1]

In Formula 1, x, a, b and z may be in a range of 0.95≤x≤1.2, 0.6≤a≤0.99, 0.01≤b≤0.4, −0.5≤z≤0.1, respectively. As described above, M may include Co, Mn and/or Al.

The chemical structure represented by Formula 1 indicates a bonding relationship between elements included in the layered structure or crystal structure of the cathode active material, and does not exclude other additional elements. For example, M includes Co and/or Mn, and Co and/or Mn may be provided as main active elements of the cathode active material together with Ni. Here, it should be understood that Formula 1 is provided to express the bonding relationship between the main active elements, and is a formula encompassing introduction and substitution of the additional elements.

In one embodiment, the cathode active material may further include auxiliary elements which are added to the main active elements, thus to enhance chemical stability thereof or the layered structure/crystal structure. The auxiliary element may be incorporated into the layered structure/crystal structure together to form a bond, and it should be understood that this case is also included within the chemical structure range represented by Formula 1.

The auxiliary element may include, for example, at least one selected from the group consisting of Na, Mg, Ca, Y, Ti, Hf, V, Nb, Ta, Cr, Mo, W, Fe, Cu, Ag, Zn, B, Al, Ga, C, Si, Sn, Sr, Ba, Ra, Por Zr. The auxiliary element may also act as an auxiliary active element which contributes to the capacity/output activity of the cathode active material together with Co or Mn like Al.

For example, the cathode active material or the lithium-nickel metal oxide may include a layered structure or crystal structure represented by Formula 1-1 below.

LiₓNiₐM1_{b1}M2_{b2}O_{2+z} [Formula 1-1]

In Formula 1-1, M1 may include Co, Mn and/or Al. M2 may include the above-described auxiliary elements. In Formula 1-1, x, a, b1, b2 and z may be in a range of 0.95x≤1.2, 0.6≤a≤0.99, 0.01≤b1+b2≤0.4, −0.5≤z≤0.1, respectively.

The cathode active material may further include a coating element or a doping element. For example, elements which are substantially the same as or similar to the above-described auxiliary elements may be used as the coating element or the doping element. For example, the above-described elements may be used alone or in combination of two or more thereof as the coating element or the doping element.

The coating element or the doping element may exist on the surface of the lithium-nickel metal oxide particles, or may also penetrate through the surface of the lithium-nickel metal oxide particles to be included in the bonding structure represented by Formula 1 or Formula 1-1 above.

The cathode active material may include a nickel-cobalt-manganese (NCM)-based lithium oxide. In this case, an NCM-based lithium oxide with an increased content of nickel may be used.

Nickel may be provided as a transition metal related to the output and capacity of the lithium secondary battery. Therefore, as described above, by employing a high-content (High-Ni) composition in the cathode active material, a high-capacity cathode and a high-capacity lithium secondary battery may be provided.

However, as the content of Ni is increased, long-term storage stability and life-span stability of the cathode or the secondary battery may be relatively decreased, and a side reaction with the electrolyte may also be increased. However, according to exemplary embodiments, the life-span stability and capacity retention characteristics may be improved through Mn while maintaining electrical conductivity by including Co.

The content of Ni (e.g., a mole fraction of nickel based on the total number of moles of nickel, cobalt and manganese) in the NCM-based lithium oxide may be 0.5 or more, 0.6 or more, 0.7 or more, or 0.8 or more. In some embodiments, the Ni content may be 0.8 to 0.95, 0.82 to 0.95, 0.83 to 0.95, 0.84 to 0.95, 0.85 to 0.95, or 0.88 to 0.95.

In some embodiments, the cathode active material may also include a lithium cobalt oxide-based active material, a lithium manganese oxide-based active material, a lithium nickel oxide-based active material, or a lithium iron phosphate (LFP)-based active material (e.g., LiFePO₄).

In some embodiments, the cathode active material may include, for example, a Li-rich layered oxide (LLO)/over-lithiated oxide (OLO)-based active material, an Mn-rich active material, a Co-less active material, and the like, which have a chemical structure or crystal structure represented by Formula 2 below. These may be used alone or in combination of two or more thereof.

p[Li₂MnO₃]·(1−p)[Li_{q}JO₂] [Formula 2]

In Formula 2, p and q are in a range 0<p<1, 0.9≤q≤1.2, respectively, and J may include at least one element of Mn, Ni, Co, Fe, Cr, V, Cu, Zn, Ti, Al, Mg and B.

The cathode active material may be mixed in a solvent to prepare a cathode slurry. The cathode slurry may be applied to at least one surface of a cathode current collector 105, followed by drying and pressing the same to prepare the cathode active material layer 110. The coating may include a method such as gravure coating, slot die coating, simultaneous multilayer die coating, imprinting, doctor blade coating, dip coating, bar coating or casting. The cathode active material layer 110 may further include a binder, and optionally further include a conductive material, a thickener or the like.

As the solvent, N-methyl-2-pyrrolidone (NMP), dimethylformamide, dimethylacetamide, N,N-dimethylaminopropylamine, ethylene oxide, tetrahydrofuran, and the like may be used.

The binder may include polyvinylidene fluoride (PVDF), poly (vinylidene fluoride-co-hexafluoropropylene), polyacrylonitrile, polymethylmethacrylate, acrylonitrile butadiene rubber (NBR), polybutadiene rubber (BR), styrene-butadiene rubber (SBR) and the like. These may be used alone or in combination of two or more thereof.

In one embodiment, a PVDF-based binder may be used as the cathode binder. In this case, the amount of binder for forming the cathode active material layer 110 may be decreased and the amount of the cathode active material may be relatively increased. Accordingly, the output characteristics and capacity characteristics of the secondary battery may be improved. The conductive material may be added to the cathode active material layer 110 in order to enhance the conductivity thereof and/or the mobility of lithium ions or electrons. For example, the conductive material may include a carbon-based conductive material such as graphite, carbon black, acetylene black, Ketjen black, graphene, carbon nanotubes (CNTs), vapor-grown carbon fibers (VGCFs), carbon fibers, and/or a metal-based conductive material including tin, tin oxide, titanium oxide, or a perovskite material such as LaSrCoO₃, and LaSrMnO₃. These may be used alone or in combination of two or more thereof.

The cathode slurry may further include a thickener and/or dispersant. In one embodiment, the cathode slurry may include a thickener such as carboxymethyl cellulose (CMC).

The anode 130 may include an anode current collector 125 and an anode active material layer 120 formed on at least one surface of the anode current collector 125.

The anode active material may be mixed in a solvent to prepare an anode slurry. The anode slurry may be applied/deposited to the anode current collector 125, followed by drying and pressing the same to prepare the anode active material layer 120. The coating may include a method such as gravure coating, slot die coating, simultaneous multilayer die coating, imprinting, doctor blade coating, dip coating, bar coating or casting. The anode active material layer 120 may further include a binder, and optionally further include a conductive material, a thickener or the like.

The solvent included in the anode slurry may include water, pure water, deionized water, distilled water, ethanol, isopropanol, methanol, acetone, n-propanol, t-butanol and the like. These may be used alone or in combination of two or more thereof.

The above-described materials that can be used when manufacturing the cathode 100 as the binder and thickener may be used.

In some embodiments, a styrene-butadiene rubber (SBR)-based binder, carboxymethyl cellulose (CMC), polyacrylic acid (PAA)-based binder, poly(3,4-ethylenedioxythiophene, PEDOT)-based binder, and the like may be used as an anode binder. These may be used alone or in combination of two or more thereof.

In some embodiments, a loading amount ratio defined by Equation 2 below may be 35% to 60%, and in one embodiment 40% to 50%.

Loading amount ratio (%)=(LC/LA)×100 [Equation 2]

In Equation 2, LC is a loading amount (mg/cm²) of the cathode 100, and LA is a loading amount (mg/cm²) of the anode 130.

Within the above loading amount ratio range, a capacity of the anode 130 is appropriately adjusted relative to the capacity of the cathode 100, such that excessive volume expansion of the anode 130 may be suppressed and the initial efficiency and lifespan characteristics may be improved.

The term “loading amount” used herein indicates a weight of an electrode active material layer loaded per unit area of the electrode. For example, the loading amount (LC) of the cathode 100 may be a weight of the cathode active material layer 110 loaded per unit area of the cathode 100. For example, the loading amount (LA) of the anode 130 may be a weight of the anode active material layer 120 loaded per unit area of the anode 130.

For example, the loading amount (LC) of the cathode 100 may be changed by adjusting the thickness of the cathode active material layer 110. The loading amount (LA) of the anode 130 may be changed by adjusting the thickness of the anode active material layer 120. The loading amount may also be changed by varying the composition of the cathode active material layer 110 and/or the composition of the anode active material layer 120.

In exemplary embodiments, a separation membrane 140 may be interposed between the cathode 100 and the anode 130. The separation membrane 140 may be configured to prevent an electrical short-circuit between the cathode 100 and the anode 130, and to allow a flow of ions to occur. For example, the separation membrane may have a thickness of 10 μm to 20 μm.

For example, the separation membrane 140 may include a porous polymer film or a porous nonwoven fabric.

The porous polymer film may include a polyolefin polymer such as an ethylene polymer, a propylene polymer, an ethylene/butene copolymer, an ethylene/hexene copolymer, and an ethylene/methacrylate copolymer, etc. These may be used alone or in combination of two or more thereof.

The porous nonwoven fabric may include glass fibers having a high melting point, polyethylene terephthalate fibers and the like.

The separation membrane 140 may also include a ceramic-based material. For example, inorganic particles may be applied to the polymer film or dispersed within the polymer film to improve heat resistance.

The separation membrane 140 may have a single-layer or multi-layer structure including the above-described polymer film and/or non-woven fabric.

According to exemplary embodiments, an electrode cell is defined by the cathode 100, the anode 130 and the separation membrane 140, and a plurality of electrode cells are stacked to form, for example, a jelly roll type electrode assembly 150. For example, the electrode assembly 150 may be formed by winding, stacking, z-folding, stack-folding, etc. of the separation membrane 140.

The electrode assembly 150 may be housed in a case 160 together with an electrolyte to define a lithium secondary battery. According to exemplary embodiments, a non-aqueous electrolyte may be used as the electrolyte.

The non-aqueous electrolyte includes a lithium salt of an electrolyte and an organic solvent, the lithium salt is represented by, for example, Li⁺X⁻, and as an anion (X⁻) of the lithium salt, F⁻, Cl⁻, Br⁻, I⁻, NO₃⁻, N(CN)₂⁻, BF₄⁻, ClO₄⁻, PF₆⁻, (CF₃)₂PF₄⁻, (CF₃)₃PF₃⁻, (CF₃)₄PF₂⁻, (CF₃)₅PF⁻, (CF₃)₆P⁻, CF₃SO₃⁻, CF₃CF₂SO₃⁻; (CF₃SO₂)₂N⁻, (FSO₂)₂N⁻; CF₃CF₂(CF₃)₂CO⁻, (CF₃SO₂)₂CH⁻, (SF₅)₃C⁻, (CF₃SO₂)₃C⁻,CF₃(CF₂)₇SO₃⁻; CF₃CO₂⁻, CH₃CO₂⁻, SCN⁻ and (CF₃CF₂SO₂)₂N⁻, etc. may be exemplified.

As the organic solvent, for example, propylene carbonate (PC), ethylene carbonate (EC), butylene carbonate, diethyl carbonate (DEC), dimethyl carbonate (DMC), ethyl methyl carbonate (EMC), methylpropyl carbonate, ethylpropyl carbonate, dipropyl carbonate, vinylene carbonate, methyl acetate (MA), ethyl acetate (EA), n-propylacetate (n-PA), 1,1-dimethylethyl acetate (DMEA), methyl propionate (MP), ethyl propionate (EP), fluoroethyl acetate (FEA), difluoroethyl acetate (DFEA), trifluoroethyl acetate (TFEA), dibutyl ether, tetraethylene glycol dimethyl ether (TEGDME), diethylene glycol dimethyl ether (DEGDME), dimethoxyethane, tetrahydrofuran (THF), 2-methyltetrahydrofuran, ethyl alcohol, isopropyl alcohol, dimethyl sulfur oxide, acetonitrile, diethoxyethane, sulfolane, gamma-butyrolactone, and propylene sulfite, and the like may be used. These may be used alone or in combination of two or more thereof.

The non-aqueous electrolyte may further include an additive. The additive may include, for example, a cyclic carbonate compound, a fluorine-substituted carbonate compound, a sultone compound, a cyclic sulfate compound, a cyclic sulfite compound, a phosphate compound, a borate compound and the like. These may be used alone or in combination of two or more thereof.

The cyclic carbonate compound may include vinylene carbonate (VC), vinyl ethylene carbonate (VEC), etc.

The fluorine-substituted carbonate compound may include fluoroethylene carbonate (FEC), etc.

The sultone compound may include 1,3-propane sultone, 1,3-propene sultone, 1,4-butane sultone, etc.

The cyclic sulfate compound may include 1,2-ethylene sulfate, 1,2-propylene sulfate, etc.

The cyclic sulfite compound may include ethylene sulfite, butylene sulfite, etc.

The phosphate compound may include lithium difluoro bis-oxalato phosphate, lithium difluoro phosphate, etc.

The borate compound may include lithium bis(oxalate) borate, etc.

In some embodiments, a solid electrolyte may also be used instead of the above-described non-aqueous electrolyte. In this case, the lithium secondary battery may be manufactured in the form of an all-solid-state battery. In addition, a solid electrolyte layer may also be disposed between the cathode 100 and the anode 130 instead of the above-described separation membrane 140.

The solid electrolyte may include a sulfide-based electrolyte. As a non-limiting example, the sulfide-based electrolyte may include Li₂S—P₂S₅, Li₂S—P₂S₅-LiCl, Li₂S—P₂S₅—LiBr, Li₂S—P₂S₅—LiCl—LiBr, Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (m and n are positive numbers, Z is Ge, Zn or Ga), Li₂S—GeS₂, Li₂S—SiS₂—Li₃PO₄, Li₂S—SiS₂—LiₚMO_{q} (p and q are positive numbers, M is P, Si, Ge, B, Al, Ga or In), Li₇−xPS₆−xClₓ (0≤x≤2), Liz-xPS₆-xBrₓ (0≤x≤2), Li₇−xPS₆−XIₓ (0≤x≤2), etc. These may be used alone or in combination of two or more thereof.

In one embodiment, the solid electrolyte may also include an oxide-based amorphous solid electrolyte, such as, for example, Li₂O—B₂O₃—P₂O₅, Li₂O—SiO₂, Li₂O—B₂O₃, Li₂O—B₂O₃—ZnO, etc.

As shown in FIGS. 1 and 2, electrode tabs (a cathode tab and an anode tab) may protrude from the cathode current collector 105 and the anode current collector 125, respectively, which belong to each electrode cell, and may extend to one side of the case 160. The electrode tabs may be fused together with the one side of the case 160 to form electrode leads (a cathode lead 107 and an anode lead 127) extending or exposed to an outside of the case 160.

The lithium secondary battery may be manufactured, for example, in a cylindrical shape using a can, a square shape, a pouch type or a coin shape.

Hereinafter, embodiments of the present disclosure will be further described with reference to specific experimental examples. However, the following examples and comparative examples included in the experimental examples are only given for illustrating the present disclosure and those skilled in the art will obviously understand that various alterations and modifications are possible within the scope and spirit of the present disclosure. Such alterations and modifications are duly included in the appended claims.

### Example 1

### Preparation of Anode

Silicon metal containing silicon in a content of 80 wt % to 100 wt % was used as an anode active material.

An anode slurry was obtained by mixing 80 wt % of the anode active material, 10 wt % of carbon black (Super C, manufactured by Timcal Graphite & Carbon Inc.) as a conductive material, and 10 wt % of polyacrylic acid (PAA) as a binder.

An anode, which includes an anode active material layer formed by applying the anode slurry to a copper substrate, followed by drying and pressing the same, was prepared. The anode was formed to have a loading amount (LA) of 3.77 mg/cm² by adjusting the thickness of the anode active material layer.

### Manufacture of Lithium Secondary Battery

A cathode slurry was prepared by mixing LiNi_{0.8}Co_{0.1}Mn_{0.1}O₂ as a cathode active material, carbon black as a conductive material, and polyvinylidene fluoride (PVdF) as a binder in a weight ratio of 93:5:2.

The cathode slurry was applied to an aluminum current collector, followed by drying and pressing the same to prepare a cathode. A loading amount (LC) of the cathode was adjusted to 1.505 mg/cm².

A lithium coin cell of CR2016 (diameter 20 mm, thickness 1.6 mm) standard was manufactured by interposing a separation membrane (polyethylene, thickness 20 μm) between the cathode and the anode.

A combination of cathode/separation membrane/anode was put in a coin cell plate, an electrolyte was injected, and then a cap was covered and clamped. The electrolyte used herein was prepared by adding 2.0 vol % of fluoroethylene carbonate (FEC) based on the total volume of the electrolyte to a 1M LiPF₆ solution formed using a mixed solvent of EC/EMC (3:7; volume ratio). The manufactured lithium half-cell was impregnated for 3 to 24 hours after clamping, then formation charging and discharging were performed thereon (charging condition: CC-CV 0.2 C 4.2 V 0.05 C CUT-OFF, discharging condition: CC 0.2 C 2.5 V CUT-OFF).

### Example 2

An anode and a lithium secondary battery were manufactured according to the same procedures as described in Example 1, except that the loading amount (LA) of the anode was adjusted to 3.01 mg/cm².

### Example 3

The silicon metal was input into a thermal CVD chamber, and heat treatment was performed at less than 600° C. while supplying a mixed gas of ethylene and argon (Ar) to prepare a silicon-based active material having a carbon coating formed on the surface portion thereof. A content of the carbon coating was 10 wt % based on the total weight of the silicon-based active material.

The content of the carbon coating was measured using a CS Analyzer (CS 844, LECO). Specifically, the silicon-based active material was input into a ceramic crucible, the weight thereof was measured, and a combustion improver (LEOCEL) and Iron chips were additionally input into the ceramic crucible. The weight of CO₂ generated by combustion of the ceramic crucible was detected by an infrared method, then converting it into a percentage to measure the content of the carbon coating.

An anode and a lithium secondary battery were manufactured according to the same procedures as described in Example 1, except that the silicon-based active material was used as an anode active material, and the loading amount (LA) of the anode was adjusted to 4.30 mg/cm².

### Example 4

An anode and a lithium secondary battery were manufactured according to the same procedures as described in Example 1, except that an anode slurry was obtained by mixing 75 wt % of the anode active material, 15 wt % of Super C as a conductive material, and 10 wt % of PAA as a binder, and the anode loading amount (LA) was adjusted to 4.30 mg/cm².

### Examples 5 to 7, and Comparative Examples 1 and 2

Anodes and lithium secondary batteries were manufactured according to the same procedures as described in Example 1, except that the anode loading amounts (LA) were adjusted as listed in Table 1.

### Example 8

An anode and a lithium secondary battery were manufactured according to the same procedures as described in Example 1, except that an anode slurry was obtained by mixing 74.5 wt % of the anode active material, 15.5 wt % of Super C as a conductive material, and 10 wt % of PAA as a binder, and the anode loading amount (LA) was adjusted to 2.51 mg/cm².

### Example 9

An anode and a lithium secondary battery were manufactured according to the same procedures as described in Example 1, except that an anode slurry was obtained by mixing 80.5 wt % of the anode active material, 9.5 wt % of Super C as a conductive material, and 10 wt % of PAA as a binder, and the anode loading amount (LA) was adjusted to 4.30 mg/cm².

### Comparative Example 3

An anode and a lithium secondary battery were manufactured according to the same procedures as described in Example 1, except that LiNi_{0.8}Co_{0.1}Mn_{0.1}O₂ was used instead of LiNi_{0.6}Co_{0.2}Mn_{0.2}O₂ as a cathode active material, and the anode loading amount (LA) was adjusted to 2.51 mg/cm².

### Comparative Example 4

An anode and a lithium secondary battery were manufactured according to the same procedures as described in Example 1, except that the anode loading amount (LA) was adjusted to 2.15 mg/cm².

The anode loading amount (LA) and cathode loading amount (LC) of the examples and comparative examples were substituted into Equation 2 to calculate the loading amount ratio, respectively.

### Experimental Example

(1) Measurement of Li/Si ratio

ICP analysis was performed on the anode active material layers of the anodes manufactured according to the examples and comparative examples to measure a silicon content (CSi) based on the total weight of the anode active material layer and a lithium content (CLi) based on the total weight of the anode active material layer, respectively.

Specifically, a sample obtained by separating the anode active material layer from the anode, nitric acid, and a small amount of hydrofluoric acid were input into a polypropylene (PP) tube, and the tube was sealed by turning a stopper. The PP tube was shaken well and left at room temperature, followed by dissolving the sample. After the sample was dissolved, the PP tube was stored in a refrigerator to cool the sample. Saturated boric acid water was added to the cooled sample to neutralize the hydrofluoric acid, and then the sample was diluted with ultrapure water. The carbon component remaining in the sample was removed with a 0.45 μm syringe filter to obtain an injection solution.

The obtained injection solution was injected into an ICP analyzer (NexION 350S, PerkinElmer) to measure contents of silicon element (CSi) and lithium element (CLi) based on the total weight of the anode active material layer, respectively.

Specifically, a high-temperature (approximately 10,000 K or lower) argon (Ar) plasma was generated using an induced magnetic field (RF frequency) in the ICP analyzer. The injection solution was injected into the ICP analyzer in an aerosol state to acquire a mass ratio and a charge ratio of cations, and a signal intensity of each ratio was detected.

The measurement conditions of the ICP analyzer were set as follows:
i) Induction magnetic field generation device (RF Generator): 40 MHz free-running ICP source Quadruple-stage vacuum system; and
ii) Detector: Quadruple ion detector

The measured CSi and CLi were substituted into Equation 1 to calculate the Li/Si ratio.

### (2) Evaluation of Initial Efficiency

Charging (CC-CV 0.2 C 4.2 V 0.05 C CUT-OFF) and discharging (CC 0.2 C 2.5 V CUT-OFF) were respectively performed once on the lithium secondary batteries of the examples and comparative examples at room temperature (25° C.) to measure initial charge capacities and initial discharge capacities.

The initial discharge capacity was divided by the initial charge capacity and multiplied by 100 to evaluate it as the initial efficiency.

### (3) Evaluation of Capacity Retention Rate (100th Cycle)

Charging (CC-CV 0.2C 4.2 V 0.05 C CUT-OFF) and discharging (CC 0.2 C 2.5 V CUT-OFF) were repeatedly performed 100 times on the lithium secondary batteries of the examples and comparative examples at room temperature (25° C.), then the discharge capacity at 100th cycle was divided by the discharge capacity at the 1st cycle and multiplied by 100 to evaluate the capacity retention rate, respectively.

The anode loading amounts, loading amount ratios, silicon contents (CSi) based on the total weight of the anode active material layer, lithium contents (CLi) based on the total weight of the anode active material layer, and Li/Si ratios are shown in Table 1.

TABLE 1

| | Anode | | | | |
|---|---|---|---|---|---|
| | loading | Loading | Silicon | Lithium | |
| | amount | amount ratio | content | content | |
| | (mg/cm²) | (%) | (wt %) | (wt %) | Li/Si ratio |
| Example 1 | 3.77 | 40 | 23.88 | 0.80 | 0.0335 |
| Example 2 | 3.01 | 50 | 20.25 | 0.92 | 0.0454 |
| Example 3 | 4.30 | 35 | 24.36 | 0.82 | 0.0337 |
| Example 4 | 4.30 | 35 | 24.74 | 0.79 | 0.0319 |
| Example 5 | 2.51 | 60 | 17.59 | 0.97 | 0.0551 |
| Example 6 | 5.02 | 30 | 24.70 | 0.76 | 0.0308 |
| Example 7 | 2.32 | 65 | 18.12 | 1.06 | 0.0584 |
| Example 8 | 2.51 | 60 | 17.50 | 1.04 | 0.0594 |
| Example 9 | 4.30 | 35 | 24.79 | 0.76 | 0.0307 |
| Comparative | 5.02 | 30 | 29.07 | 0.73 | 0.0251 |
| Example 1 | | | | | |
| Comparative | 4.30 | 35 | 26.22 | 0.77 | 0.0294 |
| Example 2 | | | | | |
| Comparative | 2.51 | 60 | 17.57 | 1.06 | 0.0603 |
| Example 3 | | | | | |
| Comparative | 2.15 | 70 | 15.54 | 1.01 | 0.0650 |
| Example 4 | | | | | |

TABLE 2

| | Initial efficiency | Capacity retention rate |
|---|---|---|
| | (%) | (%, 100th cycle) |
| Example 1 | 84.5 | 93 |
| Example 2 | 83.2 | 91 |
| Example 3 | 79.2 | 93 |
| Example 4 | 82.4 | 94 |
| Example 5 | 84.2 | 88 |
| Example 6 | 78.2 | 92 |
| Example 7 | 84.8 | 85 |
| Example 8 | 84.5 | 85 |
| Example 9 | 77.5 | 91 |
| Comparative Example 1 | 72.1 | 94 |
| Comparative Example 2 | 72.6 | 91 |
| Comparative Example 3 | 86.5 | 80 |
| Comparative Example 4 | 84.5 | 67 |

Referring to Tables 1 and 2, in the examples, where the Li/Si ratio defined by Equation 1 was 0.03 to 0.06, both the initial efficiency and the capacity retention rate were improved compared to the comparative examples.

In Example 6, where the loading amount ratio was less than 35%, the initial efficiency was decreased compared to Example 1, which was manufactured in the same manner except for the loading amount ratio.

In Example 7, where the loading amount ratio was greater than 60%, the capacity retention rate was decreased compared to Example 1, which was manufactured in the same manner except for the loading amount ratio.

In Example 8, where the silicon content based on the total weight of the anode active material layer was less than 17.59 wt %, the capacity retention rate was relatively decreased compared to the other examples.

In Example 9, where the silicon content based on the total weight of the anode active material layer was greater than 24.74 wt %, the initial efficiency was relatively decreased compared to the other examples.

### DESCRIPTION OF REFERENCE NUMERALS

100: Cathode
105: Cathode current collector
107: Cathode lead
110: Cathode active material layer
120: Anode active material layer
125: Anode current collector
127: Anode lead
130: Anode
140: Separation membrane
150: Electrode assembly
160: Case

What is claimed is:

1. Anode for a lithium secondary battery comprising:
an anode current collector; and
an anode active material layer which is disposed on at least one surface of the anode current collector, comprises a silicon-based active material, and has a Li/Si ratio of 0.03 to 0.06 defined by Equation 1 below:
$$Li / Si ratio = CLi / CSi \qquad [ Equation 1 ]$$
(in Equation 1, CLi is a content of lithium based on a total weight of the anode active material layer in a discharged state, and CSi is a content of silicon based on the total weight of the anode active material layer in the discharged state).

2. The anode for a lithium secondary battery according to claim 1, wherein the Li/Si ratio is 0.0335 to 0.0454.

3. The anode for a lithium secondary battery according to claim 1, wherein the silicon-based active material comprises silicon metal.

4. The anode for a lithium secondary battery according to claim 3, wherein the content of silicon based on a total weight of the silicon metal is 80% by weight to 100% by weight.

5. The anode for a lithium secondary battery according to claim 1, wherein the silicon-based active material comprises a carbon coating disposed on a surface portion thereof.

6. The anode for a lithium secondary battery according to claim 1, wherein the CSi of Equation 1 is 17.59% by weight to 24.74% by weight.

7. The anode for a lithium secondary battery according to claim 1, wherein the Li/Si ratio is measured through inductively coupled plasma (ICP) analysis.

8. The anode for a lithium secondary battery according to claim 1, wherein the anode active material layer further comprises a conductive material.

9. The anode for a lithium secondary battery according to claim 8, wherein the conductive material comprises at least one selected from the group consisting of graphite, carbon black, acetylene black, Ketjen black, graphene, carbon nanotube, vapor-grown carbon fiber (VGCF), carbon fiber, tin, tin oxide, titanium oxide, LaSrCoO₃ and LaSrMnO₃.

10. A lithium secondary battery comprising:
the anode for a lithium secondary battery according to claim 1; and
a cathode disposed to face the anode.

11. The lithium secondary battery according to claim 10, wherein a loading amount ratio defined by Equation 2 below is 35% to 60%:
$$Loading amount ratio ( \% ) = ( LC / LA ) \times 100 \qquad [ Equation 2 ]$$
(in Equation 2, LC is a loading amount (mg/cm²) of the cathode, and LA is a loading amount (mg/cm²) of the anode).

12. The lithium secondary battery according to claim 11, wherein the loading amount ratio is 40% to 50%.
